(19) United States
(12) Patent Application Publication
(10) Pub. No.: US 2012/0286701 A1
(43) Pub. Date: Nov. 15, 2012

(54) Light Emitting Diode Light Source With Layered Phosphor Conversion Coating

(75) Inventors: Liu Yang, Yorba Linda, CA (US); Fang Sheng, Yorba LInda, CA (US)

(73) Assignees: Fang Sheng, Yorba Linda, CA (US); Liu Yang, Yorba Linda, CA (US)

(21) Appl. No.: 13/465,375

(22) Filed: May 7, 2012

Related U.S. Application Data
(60) Provisional application No. 61/518,563, filed on May 9, 2011.

(51) Int. Cl. H05B 33/12

(52) U.S. Cl. 315/312

(57) ABSTRACT

The LED (light emitting diode) light source that includes an LED chip or an array of LED chips that emit blue, or UV, violet, or other narrow wavelength light and a phosphor conversion coating that absorbs the radiation from the LED and re-emits lights of longer wavelengths and with wider spectrum of wavelength. The phosphor conversion coating includes a plurality of layered phosphor films wherein adjacent phosphor films are formed of different phosphor materials. A method of forming an LED light source includes soldering LED chip to an electrically insulating substrate and forming a phosphor conversion layer. Forming the phosphor conversion layer includes depositing a number of adjacent phosphor films directly on the surface of the LED chip or on the surface of an optically transparent substrate which may be of curved or flat surface.

### BACKGROUND

Light emitting diode (LED) was invented almost ninety years ago and has been receiving a great deal of attention since. In particular, the discovery of blue light LED in 1990s has led to a drastic improvement in conversion efficiency of electric energy to light. This has made it possible to use LED for general lighting purpose. In fact, the recent years has witnessed rapid adoption of LED in many applications, including general lighting, automobile lighting, cell phone keyboard lighting, and flat TV edge lighting. The main reasons for such rapid adoption are that (1) an LED light can be much more efficient than traditional lighting sources such as incandescent light bulbs or fluorescent tubes, (2) it can have much longer service lifetime, (3) it is more flexible and can be made into any shape to fit any lighting space requirement, and (4) it is made of materials benign to the environment.

Since the light generated from an LED is determined by the bandgap energy of the semiconductor material from which the LED is made, it is of single wavelength with very narrow distribution, while for light purpose, especially general lighting purpose, the light source with a wide spectrum of wavelength, preferable white light similar to natural light, is desired. There are basically two ways to produce a white light source based on LED, that is:

Approach A: Use three LEDs with three primary colors, namely, red, green and blue, to create a light source. The “white” color, though not true white, can be created by varying the light intensities of three different colored LEDs to a specific ratio.

Approach B: Form a layer of a phosphor material on the top of an LED. The phosphor absorbs the radiation emitted from the LED and re-emits light with a spectrum of longer wavelength, for example, yellow light when a YAG:Ce³⁺ phosphor is used.

Though appearing an ideal solution for a white LED light source, Approach A has not been in practical use. This is due to the following reasons: the complexity of the light source system, the high cost of such a complicated system, and the efficiency gaps between the three colored LEDs that makes the overall efficiency of the system lower. On the other hand, the above reasons that prohibit Approach A from the wide adoption make Approach B popular for white LED sources. FIG. 1 shows a schematic of using approach B to convert a narrow wavelength band light emitted from an LED to the light of longer wavelength and wider wavelength spectrum. The ray of light 102 emitted from an LED chip 101, for example, has a peak wavelength of 480 nm, or blue light, but its energy is concentrated within a very narrow wavelength range. To convert such a narrow wavelength banded blue light into useful white light, a phosphor conversion coating 103 is placed on the top of the LED chip. Part of incident light 102 passes through phosphor conversion coating 103, while the rest is absorbed and converted to the light with longer wavelength 104. The combination of light ray 101 and 104 appears white light to human eyes.

The approach B, however, suffers the following shortcomings: (1) The so-called “white” LED light source is not true white. As shown in FIG. 1, the most popular scheme currently used for the generation of white light from blue LED uses YAG:Ce³⁺ (or (Y,Ga)₅Al₅O₁₂:Ce³⁺) phosphor to coat InGaN LED surface. Part of the incident blue radiation is absorbed by the YAG phosphor coating which then re-emits yellow light, while the rest of blue light passes through the phosphor coating. The combination of the blue and yellow light stimulates the receptors of human eyes and appears white. Adding phosphors with red emission may improve the color rendering (higher color rendering index, or CRI), but it comes at the price of sacrificing the efficiency of the light source. (2) The absorption of blue LED light by the phosphor is not efficient enough, resulting in the loss of efficiency of converting electrical energy to light. On the other hand, the light re-emitted from the phosphor may extend to the range of wavelength that can not be sensed by human eyes, leading to more loss of brightness. Therefore, it is desirable that the absorption spectrum of the phosphor coating should be identical to the emission spectrum of the LED radiation, while the emission spectrum of the phosphor should be identical to the human sensitivity spectrum to the light. However, it is almost impossible to find a single phosphor that can meet both of these requirements to be an ideal one.

Consequently, improved phosphor coatings for the use of white LED lighting and means to form such coatings are needed.

### SUMMARY OF THE INVENTION

In general, in one aspect, the invention features an LED light source. The LED light source includes an LED chip or an array of LED chips that emit blue, or UV, violet, or other narrow wavelength light and a phosphor conversion coating that absorbs the radiation from the LED and re-emits lights of longer wavelengths and with wider spectrum of wavelength. The phosphor conversion coating includes a plurality of layered phosphor films wherein adjacent phosphor films are formed of different phosphor materials. The phosphor conversion coating can be placed directly on the top of an LED chip or an array of LED chips, or some distance away from the LED chip or the array of LED chips. In the latter case, the phosphor coating is formed on a curved or flat transparent substrate.

Implementations may include one or more of the following features. The thickness of phosphor conversion coating may have a thickness ranging from less than 1 microns to a few hundred microns. The phosphor conversion coating may be adjacent to the surface of the LED chip, or separated with some distance. A phosphor film formed of the same phosphor material may be separated along at least a subsection by a different phosphor film. The phosphor materials can be of yellow, red or green light emitting materials. The yellow phosphor materials (emitting yellow phosphors) can be selected from but not limited to the following: (Y,Gd)₃Al₅O₁₂:Ce³⁺ and (Sr,Ba)₂SiO₄:Eu²⁺ The red phosphor materials (emitting yellow phosphors) can be selected from but not limited to the following: CaAlSiN₃:Eu²⁺ and CaS:Eu²⁺. The green phosphor materials (emitting yellow phosphors) can be selected from but not limited to the following: MSi₂O₂N₂:Eu²⁺ (M=Ca²⁺, Sr²⁺, Ba²⁺). The LED light source may be a single LED chip or an array of LED chips that emit blue, UV or other wavelength of light.

In general, in another aspect, the invention features a method if forming a phosphor conversion LED light source. The method includes forming a phosphor conversion coating that converts narrow wavelength banded light emitted from an LED chip or an array of LED chips to the light radiation with longer wavelength and wider wavelength spectrum. Forming the phosphor conversion coating includes depositing a number of adjacent phosphor layers directly on the surface of an LED chip or an array of LED chips. Forming the phosphor conversion coating also includes depositing a number of adjacent phosphor layers directly on a curved or flat optically transparent substrate.

Implementations may include one or more of the following features. Additional phosphor layers may be deposited to form the phosphor conversion coating. For example, a third phosphor layer can be deposited over the second phosphor layer. The first and the third phosphor layers may be of the same materials and may be separated from each other by the second phosphor layer which is of a different phosphor material. Forming a phosphor conversion LED light source may include forming an LED chip or an array of LED chips on a substrate and covering the LED chip or array of LED chips with curved or flat optically transparent substrate coated with the phosphor conversion coating.

Implementations may include one or more of the following advantages. A multilayer phosphor conversion coating can be used to provide more efficient conversion of narrow wavelength LED light to wider wavelength spectrum of light. The LED light source with a multilayered phosphor conversion coating may exhibit improved lighting quality including color rendering index and color temperature. The LED light source with multilayered phosphor coating may also exhibit improved high temperature stability and have improved lifetime.

### DESCRIPTION OF DRAWINGS

FIG. 1 shows a schematic of phosphor conversion LED light source.

FIGS. 2A -2D show LED light sources with phosphor conversion layer directly on the surface of LED chip.

FIGS. 3A-3D show cross sectional views of phosphor conversion layers.

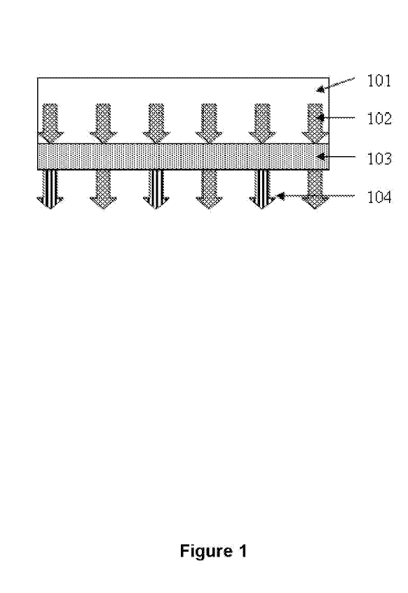

### DETAILED DESCRIPTION

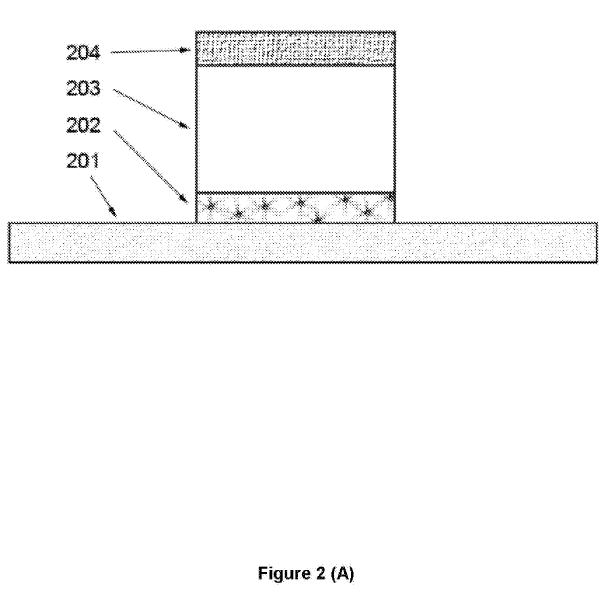

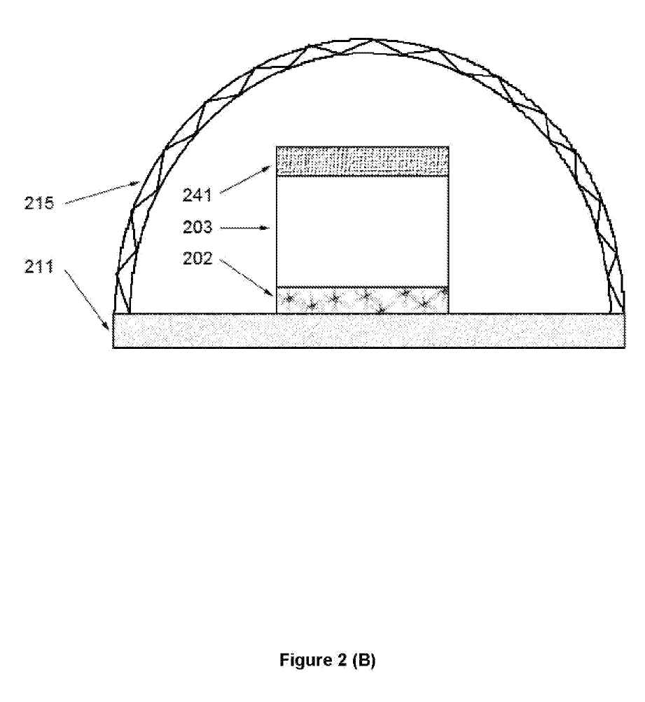

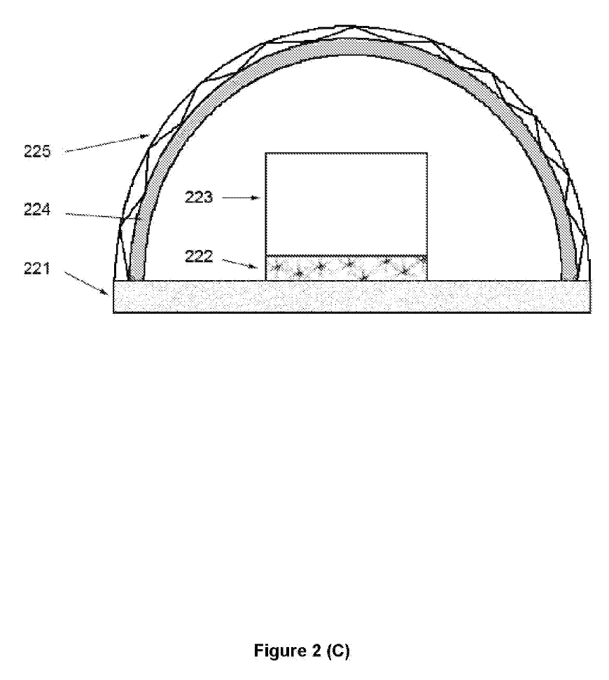

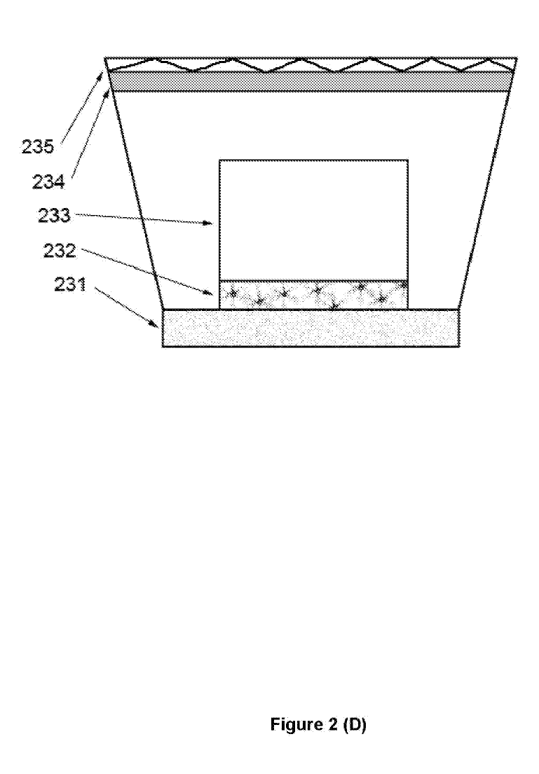

FIGS. 2A-2D show phosphor conversion LEDs that include a substrate 201 (or 211, or 221, or 231), a layer of solder 202 (or 212, or 222, or 232), an LED chip (junction) 203 (or 213, or 223, or 233), a phosphor conversion coating 204 (or 214, or 224, or 234), and/or an optical lens 215 (or 225, or 235). The LED junction 203 (or 213, or 223, or 233) can be a single LED chip (junction) or an array of LED chips. The layer of solder is used to connect LED chip(s) to the substrate 202 (or 212, or 222, or 232). The substrate should be an electrical insulator. The phosphor conversion coating 204 can be placed directly on the top of LED chip 201, as shown in FIG. 2A and FIG. 2B, or placed on the inner surface of the optical lens 225 (or 235), as shown in FIG. 2C and FIG. 2D. The optical lens 225 (or 235) is used for better light distribution emitted from the system.

The phosphor conversion coating 204 (or 214, or 224, or 234) can be formed by depositing phosphor materials directly on the top of LED chip(s) 203 (or 213, or 223, or 233) or some distance away from the chip, that is, on the inner surface of optical lens 225 (or 235). Ideally, the phosphor conversion coating should have an absorption spectrum exactly the same as that of the LED chip for 100% absorption, and its emission spectrum should fit to what is needed by end users. For example, in an ideal white LED lighting source, the emission spectrum should be from wavelength of 300 nm to 700 nm, and have a distribution resulting in maximum luminous output. The phosphor coating should also have excellent high temperature resistance and stability, ensuring long and lasting performance. These criteria can be difficult to meet when a single phosphor material is used to form a phosphor conversion coating. For example, a phosphor conversion coating formed from a single phosphor material does not absorb all the light energy emitted from the LED source 301.

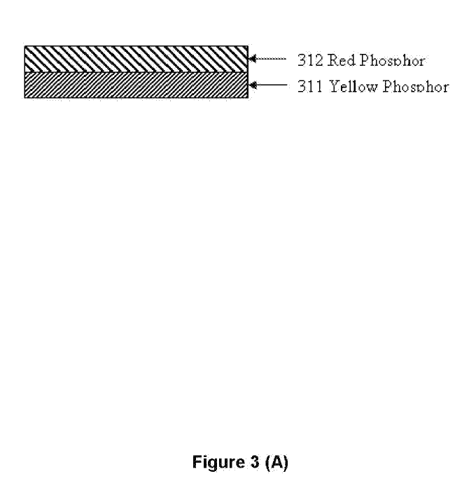

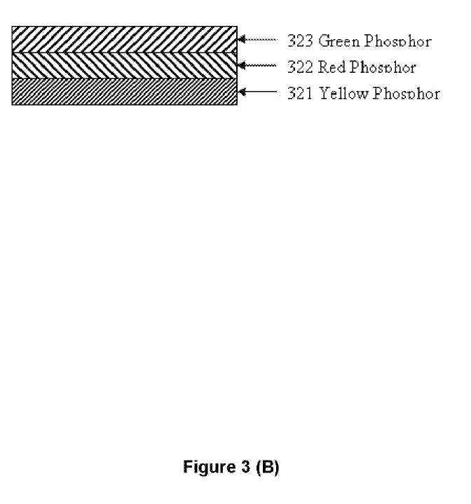

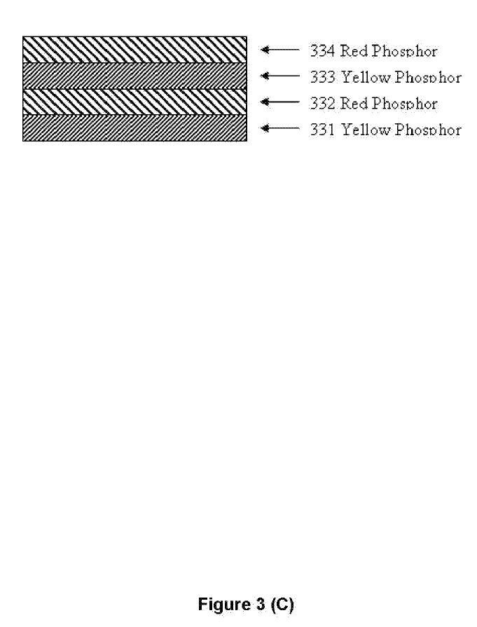

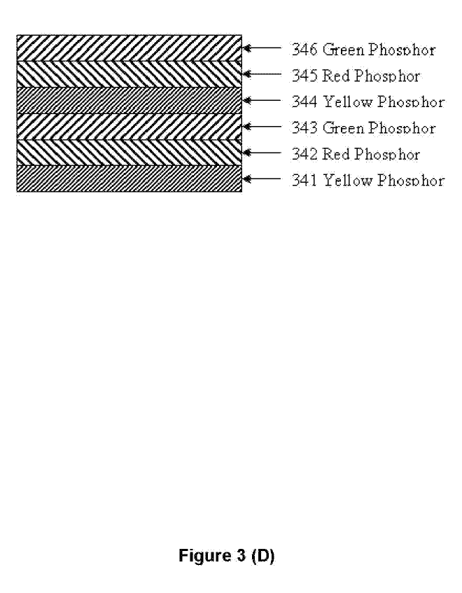

Improved phosphor conversion may be realized by forming a phosphor conversion coating from multiple layers of different phosphor materials (or “layered phosphor conversion coating”). FIGS. 3A-3C show some examples of phosphor conversion coatings 310, 320, 330 and 340. The phosphor conversion coatings 310, 320, 330 and 340 are each formed with two or more layers of different phosphor materials. For examples, phosphor conversion coating 310 is formed from a bottom layer of yellow phosphor (emitting yellow light when radiated by LED light) 311 and a top layer of red phosphor (emitting red light when radiated by LED light) 312; phosphor conversion coating 320 formed from a bottom layer of yellow phosphor 321, a middle layer of red phosphor 322 and a top layer of green phosphor 323; phosphor conversion coating 330 formed by repeating the scheme used to form phosphor conversion coating 310; and phosphor conversion coating 340 formed by repeated the same scheme to form phosphor conversion coating 320. In all the processes to form above said phosphor conversion layers, the total thickness and thickness of each red, green or yellow phosphor layer should be designed to achieve the maximum absorption of incident LED light, desired conversion efficiency and emitting light spectrum.

The yellow phosphor materials (emitting yellow phosphors) can be selected from but not limited to the following: (Y,Gd)₃Al₅O₁₂:Ce³⁺ and (Sr,Ba)₂SiO₄:Eu²⁺ The red phosphor materials (emitting yellow phosphors) can be selected from but not limited to the following: CaAlSiN₃:Eu²⁺ and CaS:Eu²⁺. The green phosphor materials (emitting yellow phosphors) can be selected from but not limited to the following: MSi₂O₂N₂:Eu²⁺ (M=Ca²⁺, Sr²⁺, Ba²⁺).

The phosphor conversion coating 204 (or 214, or 224, or 234), however, is not necessary to be formed only with the combination of yellow, red or green phosphor material layers.

Improved phosphor conversion coatings 410, 420, and 430 can be formed by depositing different phosphor materials on top of each other using known deposition techniques known in semiconductor and other industry. For example, physical vapor deposition (PVD), chemical vapor deposition, atomic layer deposition (ALD), spray, spin coating, etc. For example, PVD (for example, sputtering) technique can be used to deposit Ce⁺³ doped garnets (such as YAG:Ce³⁺), nitride and oxynitride phosphors, or oxide, oxyhalide and halide phosphors. The same phosphor materials can also be formed using CVD or spray costing techniques.

Layered phosphor conversion coatings can be incorporated in an LED light source 200 wherever a phosphor conversion is needed. For example, a layered phosphor conversion coating 320 can be used to convert the light directly emitted from an LED chip Construction of an LED light source shown in FIG. 2C is briefly described as follows: A blue light emitting LED chip or an array of such LED chips are soldered on to an electrically insulating substrate 221. The phosphor conversion coating 320 is formed on the optical lens 225 using sputtering technique or spray coating technique. Then the optical lens 225 coated with the phosphor conversion coating 320 is placed to cover the LED chip 221. In another example, a phosphor conversion coating 320 is formed directly on the LED chip 201 which is soldered onto an electrically insulating substrate 210.

As the LED chip is connected to the substrate 211 or 221, the sequence and thickness of the sub-layers of the phosphor conversion coating 320 can be “tuned” in such a way that a maximum absorption of the incident LED light can be achieved. Layer 320 may be repeatedly formed each other to achieve the maximum absorption. The sequence and thickness of the sub-layers of the phosphor conversion coating 320, or the number of the phosphor conversion coating 320, may be “tuned” to achieve optimal efficiency and lighting quality (e.g. color rendering index) of the overall system 200.

A number of embodiments of the present invention have been described. Nevertheless, it will be understood that various modifications may be made without departing from the spirit and scope of the invention. For example, the phosphor conversion coating can be formed on an optical transparent substrate with a flat surface, or any other shaped surface that may be needed to fit specific applications or meet specific requirements. In addition, although non-adjacent phosphor layers in the phosphor conversion coating are shown as being separated by intermediate layers, in some implementations the non-adjacent layers may be in contact along a region, for example, at an edge. Accordingly, other embodiments are within the scope of the following claims.

What is claimed is:

1. An LED lighting source comprising:
a. an LED or an array of LEDs that emit a single color (narrow wavelength band) light and,
b. a phosphor conversion coating that absorbs the light of LED(s) and re-emits light of longer wavelengths and wide wavelength spectrum, comprises at least a first, second and third phosphor film, wherein the said first, second and third phosphor film comprises different phosphor materials.

2. The LED lighting source of claim 1 wherein the first, second and third phosphor film each comprises the first and second surfaces, the second surface of the first phosphor film being adjacent to the first surface of the second phosphor film, and the second surface of the second phosphor film being adjacent to the first surface of the third phosphor film.

3. The LED lighting source of claim 2 wherein the phosphor conversion coating has a thickness of a few micrometers to several hundreds micrometers.

4. The LED lighting source of claim 3 wherein the first surface of the first phosphor film of the phosphor conversion coating is adjacent to the surface of the LED chip or LED array, directly on the surface of the LED(s).

5. The LED lighting source of claim 3 wherein the first surface of the first phosphor film of the phosphor conversion coating is adjacent to the surface of the LED chip or LED array, some distance away from the surface of the LED(s).

6. The LED lighting source of claim 5 wherein the second surface of the third phosphor film is adjacent to the surface of the optically transparent substrate.

7. The LED lighting source of claim 6 wherein the optically transparent substrate can be of curved surface or flat surface.

8. The LED lighting source of claim 1 wherein the first, second and third phosphor films in the phosphor conversion layer can be selected from:
a. The yellow phosphor materials (emitting yellow phosphors) can be selected from but not limited to the following: (Y,Gd)₃Al₅O₁₂:Ce³⁺ and (Sr,Ba)₂SiO₄:Eu²⁺.
b. The red phosphor materials (emitting yellow phosphors) can be selected from but not limited to the following: CaAlSiN₃:Eu²⁺ and CaS:Eu²⁺.
c. The green phosphor materials (emitting yellow phosphors) can be selected from but not limited to the following: MSi₂O₂N₂:Eu²⁺, Sr²⁺, Ba²⁺).

9. An LED lighting source comprising:
a. an LED or an array of LEDs that emit a single color (narrow wavelength band) light and,
b. a phosphor conversion coating that absorbs the light of LED(s) and re-emits light of longer wavelengths and wide wavelength spectrum, comprises at least a first, second, third, fourth, nth phosphor film, wherein the said first, second, third, fourth, . . . , nth phosphor film comprises different phosphor materials.

10. The LED lighting source of claim 1 wherein the first, second, third, fourth, . . . , nth phosphor film each comprises the first and second surfaces, the second surface of the first phosphor film being adjacent to the first surface of the second phosphor film, and the second surface of the second phosphor film being adjacent to the first surface of the third phosphor film, the second surface of the (n−1)th phosphor film being adjacent to the first surface of the nth phosphor film

11. The LED lighting source of claim 2 wherein the phosphor conversion coating has a thickness of a few micrometers to several hundreds micrometers.

12. The LED lighting source of claim 3 wherein the first surface of the first phosphor film of the phosphor conversion layer is adjacent to the surface of the LED chip or LED array, directly on the surface of the LED(s).

13. The LED lighting source of claim 3 wherein the first surface of the first phosphor film of the phosphor conversion coating is adjacent to the surface of the LED chip or LED array, some distance away from the surface of the LED(s).

14. The LED lighting source of claim 5 wherein the second surface of the nth phosphor film is adjacent to the surface of the optically transparent substrate.

15. The LED lighting source of claim 6 wherein the optically transparent substrate can be of curved surface or flat surface.

16. The LED lighting source of claim 1 wherein the first, second, third, . . . , nth phosphor films in the phosphor conversion layer can be selected from:
a. The yellow phosphor materials (emitting yellow phosphors) can be selected from but not limited to the following: (Y,Gd)₃Al₅O₁₂:Ce³⁺ and (Sr,Ba)₂SiO₄:Eu²⁺.
b. The red phosphor materials (emitting yellow phosphors) can be selected from but not limited to the following: CaAlSiN₃:Eu²⁺ and CaS:Eu²⁺.
c. The green phosphor materials (emitting yellow phosphors) can be selected from but not limited to the following: MSi₂O₂N₂:Eu²⁺ (M=Ca²⁺, Sr²⁺, Ba²⁺).
